(19) United States
(12) Patent Application Publication
(10) Pub. No.: US 2015/0248436 A1
(43) Pub. Date: Sep. 3, 2015

(54) Methods, Circuits, Devices, Systems and Associated Computer Executable Code for Assessing a Presence Likelihood of a Subject at One or More Venues

(71) Applicant: Placer Labs Inc., San Francisco, CA (US)

(72) Inventors: Johnathan Podemsky, San Francisco, CA (US); Zohar Bar-Yehuda, Givat Shmuel (IL); Noam Ben-Zvi, San Francisco, CA (US); Oded Fossfeld, Kfar Saba (IL); Ofir Lemel, Tel Aviv (IL); Nadav Hertzshtark, Tel Aviv (IL); Shai Levy, Tel Aviv (IL)

(21) Appl. No.: 14/636,209

(22) Filed: Mar. 3, 2015

Related U.S. Application Data
(60) Provisional application No. 61/946,944, filed on Mar. 3, 2014.

(51) Int. Cl. G06F 17/30; H04L 29/08; H04W 4/02

(52) U.S. Cl. CPC G06F 17/30241; H04W 4/02; G06F 17/30867; H04L 67/24; H04W 84/12

(57) ABSTRACT

Disclosed are methods, circuits, devices, systems and associated computer executable code for estimating a presence of a subject at a given venue. A mobile device carried by a subject transmits time stamped location data to a location ambiguity resolution server. The location ambiguity resolution server receives time stamped location data from the device carried by the subject; retrieves a listing of venues in proximity with the location indicated by location data; scores each of one or more of the listed venues by applying a subject preference value; and applies heuristic based score weighting or filtration to the listed venues.

### RELATED APPLICATIONS

The present invention claims priority from U.S. Provisional Patent Application No. 61/946,944, filed Mar. 3, 2014, which is hereby incorporated by reference in its entirety.

### FIELD OF THE INVENTION

Some embodiments relate generally to the fields of positioning, location tracking and/or mapping, and more particularly, to methods, circuits, devices, systems and associated computer executable code for assessing a presence likelihood of a subject at one or more venues.

### BACKGROUND

Ranking venues just by their distance to the current user location can be considered prior art (e.g. Foursquare does it at each check-in). Voluntary location tracking, however, may carry with it various benefits to user and service providers, and may assist with overcoming issues with GPS & INS based tracking, including: (a) low resolution, (b) unavailable in most indoor venues, and/or (c) ambiguity between multiple venues in proximity with one another.

Accordingly, there remains a need, in the fields of positioning, location tracking and/or mapping for technologies that may be relevant for automatic detection of venues a user has visited, while demanding no user interaction (in contrast to a user check-in process requiring user interaction). Such technologies may use signals from a computerized device carried by a user to infer more information that can be used to improve the decision process and automatically reach a better decision regarding which specific venue the device carrying user has visited.

### SUMMARY OF THE INVENTION

The present invention includes methods, circuits, devices, systems and associated computer executable code for assessing a presence likelihood of a subject at one or more venues. According to some embodiments, there may be provided a location tracking system for collecting raw physical location information from a device carried by a person, which person may also be referred to as a subject. According to further embodiments, there may be provided a location ambiguity resolution system/server to convert raw time specific and/or time stamped location data provided by a subject's device into one or more venue presence likelihood values. A venue presence likelihood value for a given venue may be indicative of a likelihood that the subject was present at the given venue at or about a time when the raw time specific location data from the subject's device indicates the subject was in proximity to the given venue. When multiple venues are in proximity to a location indicated by the raw location data, two or more of the multiple venues may be assigned a venue presence likelihood value.

According to some embodiments of the present invention, a Location Tracking System may comprise: (1) a Data Collection Logic for interfacing with one or more of the subject's device modules and utilizing them to collect raw physical location indicative information; (2) a Preprocessing Logic for generating ‘visit’ records based on the raw physical location indicative information; and/or (3) a Data Aggregation Logic for generating ‘place’ records, wherein each ‘place’ record is based on one or more ‘visit’ records.

According to some embodiments of the present invention, a Location Ambiguity Resolution System/Server may comprise: (1) a Location Data Logic for receiving time stamped location data, from the device carried by the subject, and/or receiving or referencing ‘visit’ and/or ‘place’ record(s); (2) a Venue Retrieval Logic for retrieving a listing of venues in proximity with: a location indicated by the location data, and/or a location of a ‘visit’ and/or ‘place’ record(s), received from the Location Data Logic (3) a Venue Matching Logic for scoring each of one or more of the listed venues by matching retrieved venue locations to: communication signal beacons/samples detected by the device within proximity of the location indicated by the location data, and/or to the location of the ‘visit’ and/or ‘place’ record(s); (4) a Venue Preference Logic for scoring each of one or more of the listed venues by applying a subject preference value based on a profile or preferences list of the subject; (5) a Venue Weighing Logic for applying heuristic based score weighting or filtration to the listed venues; and (6) a Venue Selection Logic for selecting a venue with an overall highest score and not violating a heuristic rule.

According to further embodiments of the present invention, for a given subject, the location ambiguity resolution system/server may: (1) receive time stamped location data from the device carried by the subject; (2) retrieve a listing of venues in proximity with a location indicated by the location data; (3) score each of one or more of the listed venues by matching communication signal beacons detected by the device within proximity of the location indicate by the location data; (4) score each of one or more of the listed venues by applying a subject preference value; (5) apply heuristic based score weighting or filtration to the listed venues; and (6) select a venue with an overall highest score and not violating a heuristic rule.

According to further embodiments of the present invention, for a given subject visit, the location ambiguity resolution system/server may apply one or more of the following heuristic based score weighting or filtration techniques: (1) Residence Classification for estimating whether the subject visit made was a visit to a private residential place or a visit to a venue; (2) WiFi features and/or characteristics comparison for matching WiFi networks details of a visit to characteristics of venues in proximity of the visit; (3) Building ‘Network(s) Signal(s) Fingerprints’ for venues formerly verified as corresponding to a visit place; (4) Comparing the operation/peak hours of venues to times of visit; (5) Determining if visits are overnight visits and filtering them accordingly; (6) Factoring the popularity of venues; (7) Listing specific large venues and applying special treatment to them; and/or (8) any other filtering, conditioning, scoring, comparing, and/or matching technique, known today or to be devised in the future.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A and 1B are functional block diagram showing the process and information flow between the main sub-systems, modules, and components, of an exemplary system for assessing a presence likelihood of a subject at one or more venues, in accordance with some embodiments of the present invention;

FIG. 2 is a functional block diagram showing the main sub-systems, modules, components, and relationships, of an exemplary system for assessing a presence likelihood of a subject at one or more venues, in accordance with some embodiments of the present invention;

FIG. 3A is a functional block diagram showing, in further detail, the main modules, components, and relationships, of an exemplary data collection logic, in accordance with some embodiments of the present invention;

FIG. 3B is a flowchart including the main processes and steps of an exemplary energy saving scheme implemented by a data collection logic, in accordance with some embodiments of the present invention;

FIG. 4 is a functional block diagram showing, in further detail, the main modules, components, and relationships, of an exemplary preprocessing logic, in accordance with some embodiments of the present invention;

FIG. 5 is a functional block diagram showing, in further detail, the main modules, components, and relationships, of an exemplary data aggregation logic, in accordance with some embodiments of the present invention;

FIG. 6 is a functional block diagram showing, in further detail, the main modules, components, and relationships, of an exemplary location data logic, in accordance with some embodiments of the present invention;

FIG. 7 is a functional block diagram showing, in further detail, the main modules, components, and relationships, of an exemplary venue retrieval logic, in accordance with some embodiments of the present invention;

FIG. 8 is a functional block diagram showing, in further detail, the main modules, components, and relationships, of an exemplary venue matching logic, in accordance with some embodiments of the present invention;

FIG. 9 is a functional block diagram showing, in further detail, the main modules, components, and relationships, of an exemplary venue preference logic, in accordance with some embodiments of the present invention;

FIG. 10A is a functional block diagram showing, in further detail, the main modules, components, and relationships, of an exemplary venue weighing logic, in accordance with some embodiments of the present invention;

FIG. 10B is a functional block diagram showing, in further detail, the main modules, components, and relationships, of an exemplary venue weighing logic-residence classification module, in accordance with some embodiments of the present invention;

FIG. 10C is a functional block diagram showing, in further detail, the main modules, components, and relationships, of an exemplary venue weighing logic-heuristic scoring module, in accordance with some embodiments of the present invention;

FIG. 10D is a flowchart including the main processes and steps of an exemplary WiFi networks names matching scheme implemented by a Heuristic Scoring Module, as part of weighing and comparing one or more WiFi related features and/or characteristics of a given subject visit to proximate venues;

FIG. 11A is a functional block diagram showing, in further detail, the main modules, components, and relationships, of an exemplary venue selection logic, in accordance with some embodiments of the present invention; and

FIGS. 11B-11D are tables showing exemplary venue scoring scenarios, wherein an exemplary venue selection logic scores and ‘selects’ a venue, based on several records for each of a set of venues found to be in proximity to the location of a subject made visit, in accordance with some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing”, “computing”, “calculating”, “determining”, or the like, may refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In addition, throughout the specification discussions utilizing terms such as “storing”, “hosting”, “caching”, “saving”, or the like, may refer to the action and/or processes of ‘writing’ and ‘keeping’ digital information on a computer or computing system, or similar electronic computing device, and may be interchangeably used. The term “plurality” may be used throughout the specification to describe two or more components, devices, elements, parameters and the like.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

Throughout the following discussions ‘WiFi Signal(s) Fingerprint’ may refer to any combination of ‘Network(s) Signal(s)/Beacon(s)’ based on which a ‘network fingerprint/map’ is generated. The source of the Signal(s)/Beacon(s) may be any network type such as, but not limited to, those transmitted/emitted/put-out by WiFi, Bluetooth, or iBeacon networks, and/or any other network types known today or to be devised in the future.

The present invention includes methods, circuits, devices, systems and associated computer executable code for assessing a presence likelihood of a subject at one or more venues. According to some embodiments, there may be provided a location tracking system for collecting raw physical location information from a device carried by a person, which person may also be referred to as a subject. According to further embodiments, there may be provided a location ambiguity resolution system/server to convert raw time specific and/or time stamped location data provided by a subject's device into one or more venue presence likelihood values. A venue presence likelihood value for a given venue may be indicative of a likelihood that the subject was present at the given venue at or about a time when the raw time specific location data from the subject's device indicates the subject was in proximity to the given venue. When multiple venues are in proximity to a location indicated by the raw location data, two or more of the multiple venues may be assigned a venue presence likelihood value.

According to further embodiments of the present invention, for a given subject, the location ambiguity resolution system/server may: (1) receive time stamped location data from the device carried by the subject; (2) retrieve a listing of venues in proximity with a location indicated by the location data; (3) score each of one or more of the listed venues by matching communication signal beacons detected by the device within proximity of the location indicate by the location data; (4) score each of one or more of the listed venues by applying a subject preference value; (5) apply heuristic based score weighting or filtration to the listed venues; and (6) select a venue with an overall highest score and not violating a heuristic rule.

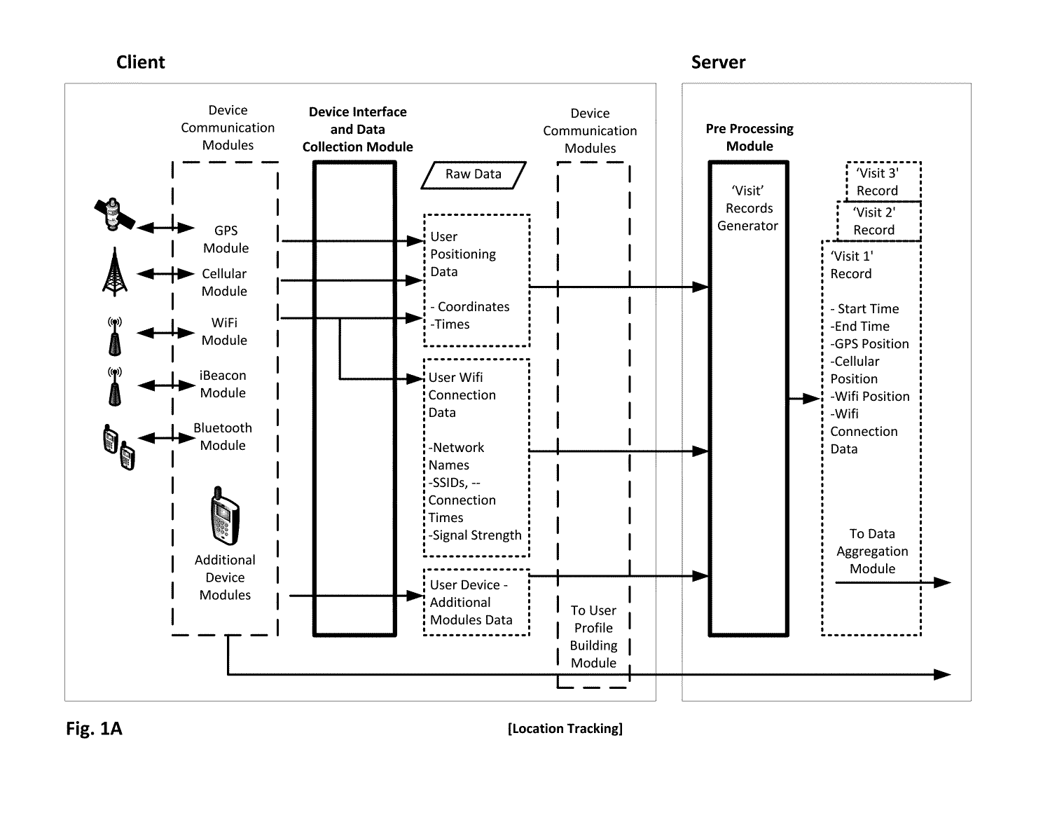

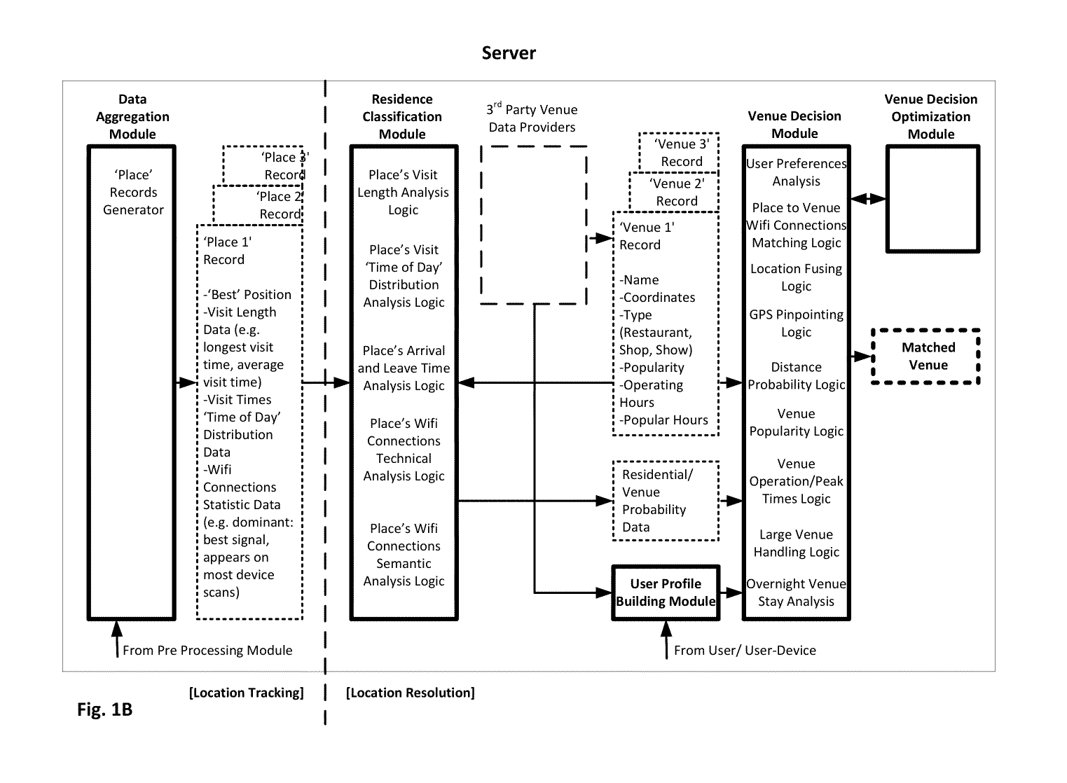

In FIGS. 1A and 1B there are shown, the process and information flow between the main sub-systems, modules, and components, of an exemplary system for assessing a presence likelihood of a subject at one or more venues, in accordance with some embodiments of the present invention.

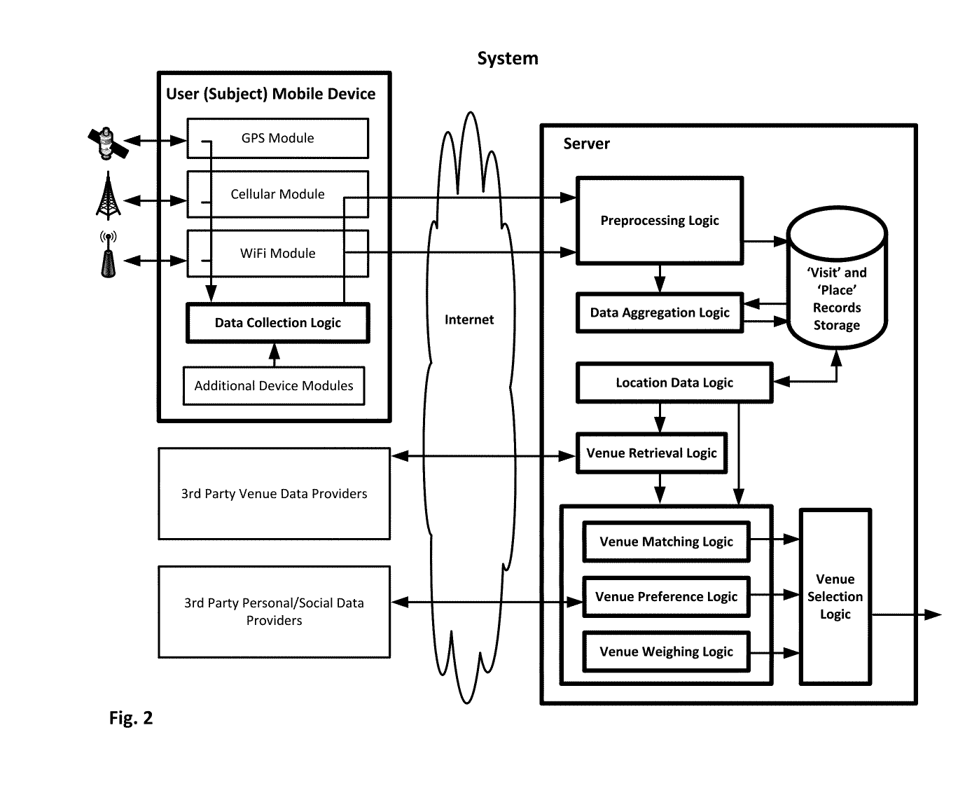

In FIG. 2 there are shown, the main sub-systems, modules, components, and relationships, of an exemplary system for assessing a presence likelihood of a subject at one or more venues, in accordance with some embodiments of the present invention.

According to some embodiments of the present invention, a Location Tracking System may comprise: (1) a Data Collection Logic for interfacing with one or more of the subject's device modules and utilizing them to collect raw physical location indicative information; (2) a Preprocessing Logic for generating ‘visit’ records based on the raw physical location indicative information; and/or (3) a Data Aggregation Logic for generating ‘place’ records, wherein each ‘place’ record is based on one or more ‘visit’ records.

According to some embodiments, the Data Collection Logic, as part of collecting raw physical location indicative information, may interface with one or more subject's device modules such as, but not limited to: (1) GPS Communication Module for collecting raw time specific and/or time stamped location data; (2) Cellular Communication Module for collecting raw time specific and/or time stamped location data; (3) WiFi Communication Module for collecting and logging WiFi networks', and/or other networks', connection parameters records and/or network scans data; and/or (4) other subject's device modules or sensors that may provide location indicative or positioning assessment improving data such as: an accelerometer, a gyroscope, a magnetometer, a barometer, a light sensor, a step counter or pedometer, a microphone, and/or a proximity or subject proximity sensor. The above modules or sensors may be used collaboratively, in any combination; and may, separately or collectively, be functionally associated with additional hardware and/or software components.

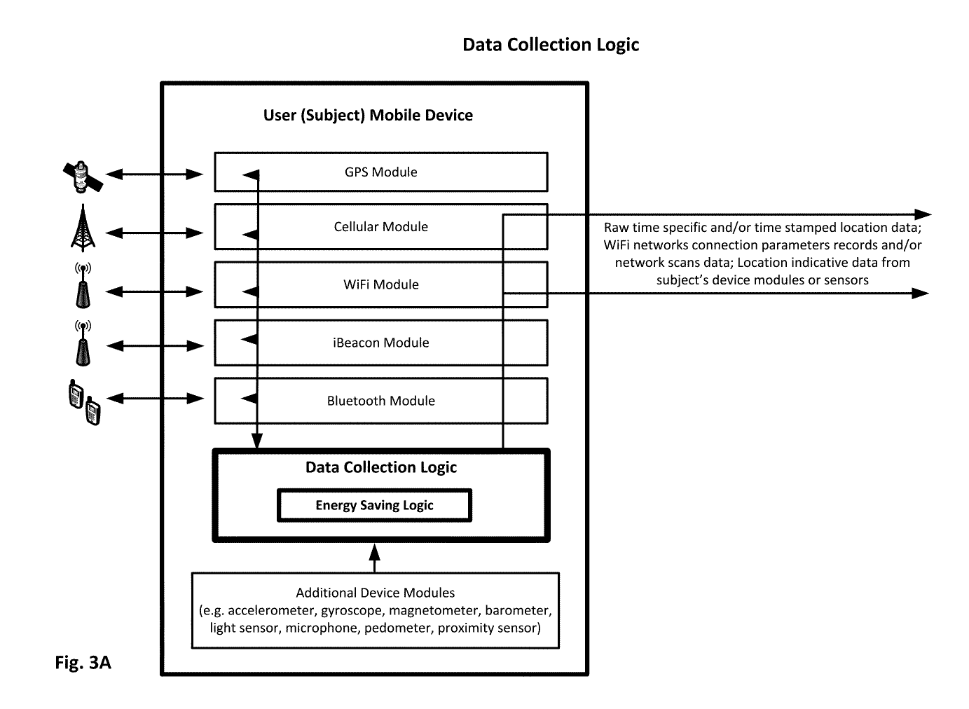

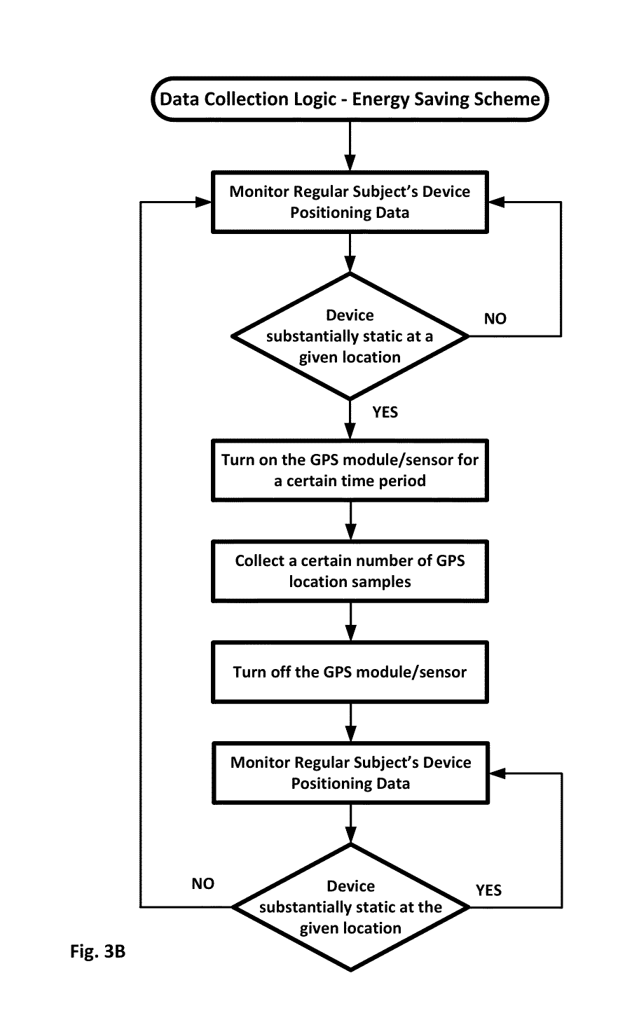

In FIG. 3A there are shown, the main modules, components, and relationships, of an exemplary data collection logic, in accordance with some embodiments of the present invention.

According to some embodiments, the collected raw physical location indicative information may be locally relayed, or communicated over a data network using the subject's device communication modules, to the Preprocessing Logic for generating ‘visit’ records. One or more consecutively collected raw physical location samples indicative of a substantially similar location, and/or any additional subject's device modules data—collected during similar location samples time stamps and between/around them, may be regarded as a ‘visit’ record. A ‘visit’ record may include: (1) Visit start time (e.g. time stamp of the first location sample from the similar location); (2) Visit end time (e.g. time stamp of the last location sample from the similar location); (3) GPS location samples collected for the visit (e.g. latitude, longitude, time, accuracy); (4) Cellular network location samples collected for the visit (e.g. latitude, longitude, time, accuracy); (5) WiFi networks connection parameters records and/or network scans data (e.g. WiFI networks names, networks SSIDs, networks connection times, received signal strength indicator (RSSI) and networks signal strength over visit time, media access control address (MAC address) identifiers utilized over visit time); and/or (6) additional data collected from the subject's device modules during the time of the visit.

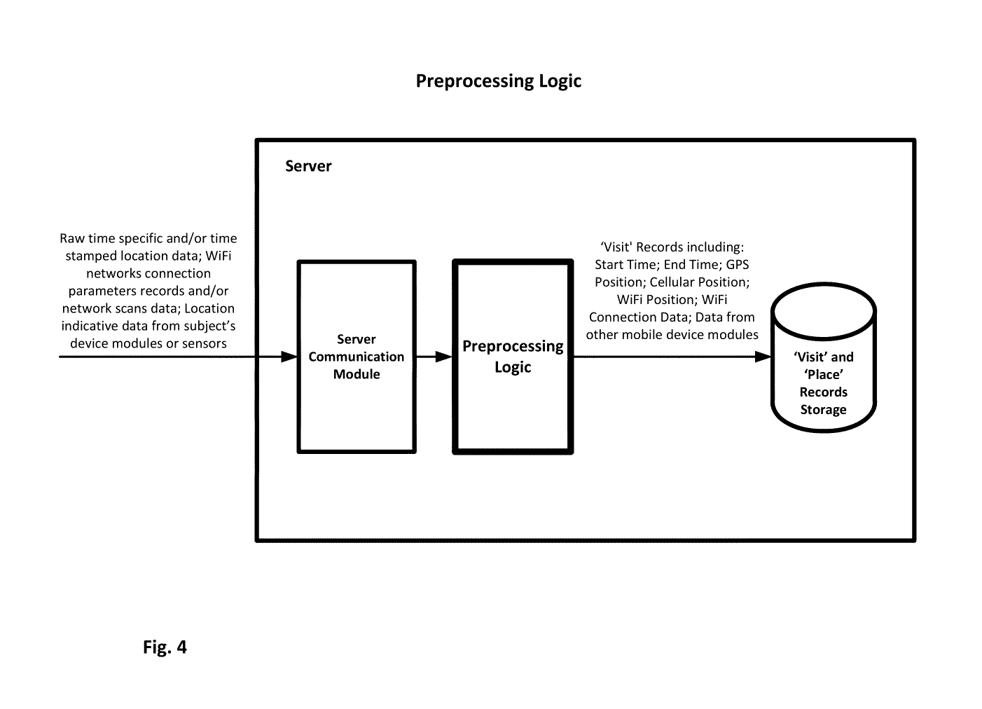

In FIG. 4 there are shown, the main modules, components, and relationships, of an exemplary preprocessing logic, in accordance with some embodiments of the present invention.

According to some embodiments, the generated ‘visit’ records, may be used by the Data Aggregation Logic for generating ‘place’ records, wherein each ‘place’ record is based on one or more ‘visit’ records of repeating visits made by the subject to the same substantially similar location. A ‘place’ record may include: (1) ‘Best’ Position determined for the location of the place based on some or all of the location indicative information gathered for the place, and possibly including location indicative information from visits made to the same place by other user device carrying subjects; (2) Place Visit-Length data and statistics (e.g. longest visit time, average visit time); (3) Place Visit-Times Data—times of arrival at and leaving of the place, ‘Time of Day’ distribution data of visits to the place (e.g. 24 Hour histogram of visit times, representing the typical hours in which the subject(s) visits the place, for example mostly around noon); (4) Place WiFi networks connection parameters records, network scans data, and/or statistical data derived from the connection parameters (e.g. dominant signal, best signal, appears on most device scans); and/or (5) additional data collected from the subject's device modules during visits to the place.

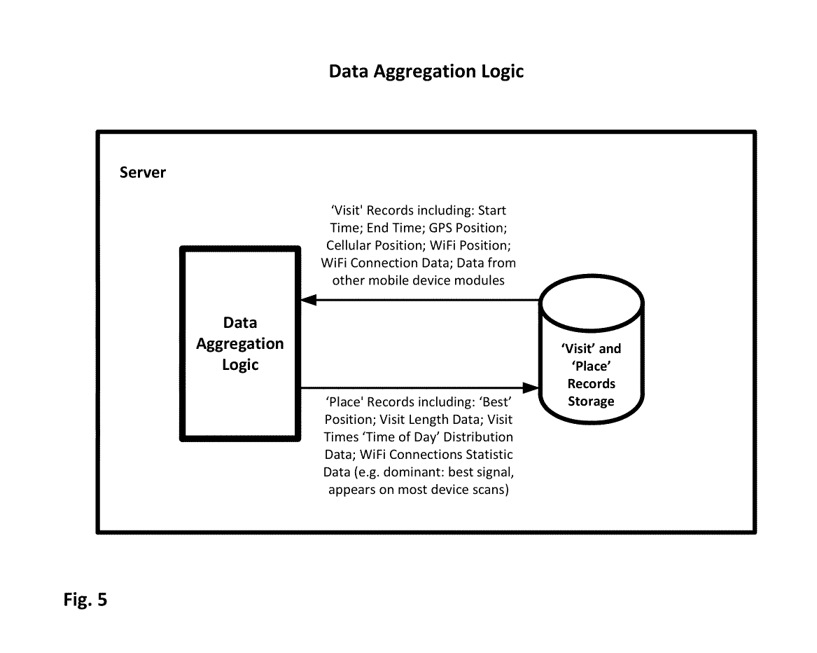

In FIG. 5 there are shown, the main modules, components, and relationships, of an exemplary data aggregation logic, in accordance with some embodiments of the present invention.

According to some embodiments, the Data Collection Logic, as part of collecting raw physical location indicative information from the GPS module of the subject's device, may comprise an energy saving logic for employing an energy saving scheme(s). The energy saving logic may, upon detecting that the subject's device is substantially static at a given location and a visit has started (e.g. two or more consecutive positioning samples, GPS based and/or other, indicating the same location), may: (1) turn on the GPS module/sensor for a given, predetermined or dynamically decided upon, time period (e.g. 1 minute); (2) collect a predetermined, or dynamically decided upon, number of GPS location samples; (3) turn off the GPS module/sensor until the current visit ends or until a new visit starts (e.g. visit end/start based on: regular/intermittent GPS position samples made by the device, cellular network positioning, WiFi based positioning, and/or location indicative information from other device modules).

In FIG. 3B there is shown, a flowchart including the main processes and steps of an exemplary energy saving scheme implemented by a data collection logic, in accordance with some embodiments of the present invention.

According to some embodiments, the energy saving logic may, upon detecting that the subject's device is at a substantially static at a given location, and a visit has started, may determine not to turn on the GPS module/sensor if the visit is to a place frequently visited in the past (e.g. home, work), assuming enough GPS location samples have already been collected at this place in the past. According to some embodiments, the energy saving logic may improve the subject's device positioning accuracy by producing GPS positioning based location(s) whose error is independent of the cellular network positioning based location(s) error. According to some embodiments, a combination of positioning data from, and/or locations based on, both cellular network and GPS sources may be weighed together by the Preprocessing Logic and/or by the Data Aggregation Logic, to produce optimal location coordinates for a given visit or place, respectively.

According to some embodiments, the energy saving logic may employ an energy saving scheme(s) wherein periodic sampling of GPS locations are collected, with no or little reliance on OS (e.g. Google Play Services) background location service(s), enhanced control over positioning data collection, less reliance on OS services that may change without notice, and better compatibility between OS versions.

According to some embodiments, the Data Collection Logic may collect multiple location samples during a single given visit made by the device carrying subject to a given place. The Preprocessing Logic may aggregate the multiple samples to generate an optimized (‘best’) set of position coordinates for the given visit. According to some embodiments, The Preprocessing Logic may derive an estimation of the accuracy level of the optimized visit coordinates based on, some or all of the accuracy levels of the multiple location samples collected during the given visit.

According to some embodiments, the Data Aggregation Logic may aggregate multiple optimized (‘best’) sets of position coordinates of multiple visits to a same place, and merge them to form one aggregated estimation for the place coordinates and/or an estimated accuracy level for the aggregated estimation.

According to further embodiments of the present invention, for a given subject, a Location Ambiguity Resolution System/Server may: (1) receive time stamped location data, from the device carried by the subject, and/or receive or reference ‘visit’ and/or ‘place’ record(s); (2) retrieve a listing of venues in proximity with: a location indicated by the location data, and/or a location of a received or referenced ‘visit’ and/or ‘place’ record(s); (3) score each of one or more of the listed venues by matching communication signal beacons detected by the device within proximity of: the location indicated by the location data, and/or the location of the ‘visit’ and/or ‘place’ record(s); (4) score each of one or more of the listed venues by applying a subject preference value; (5) apply heuristic based score weighting or filtration to the listed venues; and (6) select a venue with an overall highest score and not violating a heuristic rule.

According to some embodiments of the present invention, a Location Ambiguity Resolution System/Server may comprise: (1) a Location Data Logic for receiving time stamped location data, from the device carried by the subject, and/or receiving or referencing ‘visit’ and/or ‘place’ record(s); (2) a Venue Retrieval Logic for retrieving a listing of venues in proximity with: a location indicated by the location data, and/or a location of a ‘visit’ and/or ‘place’ record(s), received from the Location Data Logic (3) a Venue Matching Logic for scoring each of one or more of the listed venues by matching retrieved venue locations to: communication signal beacons/samples detected by the device within proximity of the location indicated by the location data, and/or to the location of the ‘visit’ and/or ‘place’ record(s); (4) a Venue Preference Logic for scoring each of one or more of the listed venues by applying a subject preference value based on a profile or preferences list of the subject; (5) a Venue Weighing Logic for applying heuristic based score weighting or filtration to the listed venues; and (6) a Venue Selection Logic for selecting a venue with an overall highest score and not violating a heuristic rule.

According to some embodiments, the Location Data Logic may receive time stamped location data, from the device carried by the subject, and/or receive or reference ‘visit’ and/or ‘place’ record(s). The time stamped location data and/or the time stamped location data of the ‘visit’ and/or ‘place’ record(s) may include the subject's device positioning coordinates, their respective time stamps, and/or their accuracy level. According to some embodiments, ‘visit’ and/or ‘place’ record(s) may each include a set of device positioning coordinates (e.g. including times and accuracies), and/or an optimized ‘best’ device positioning coordinates based on one or more device positioning coordinates samples collected during a ‘visit’ or accumulated over multiple visits, possibly by multiple subjects and subjects' devices, to a ‘place’.

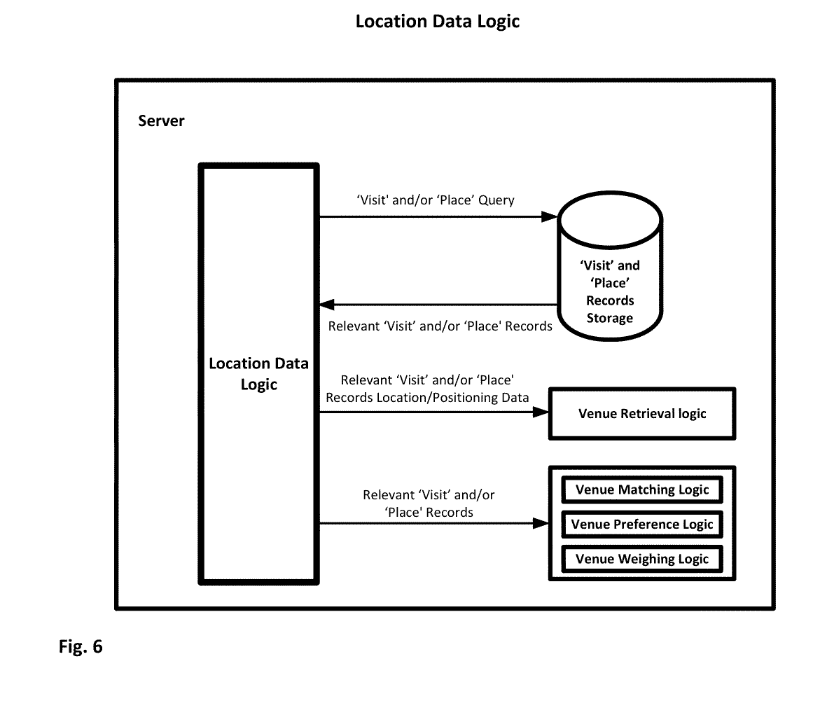

In FIG. 6 there are shown, the main modules, components, and relationships, of an exemplary location data logic, in accordance with some embodiments of the present invention;

According to some embodiments, the Venue Retrieval Logic may retrieve a listing of venues in proximity with a location indicated by the location data, and/or a location of a ‘visit’ and/or ‘place’ record(s), received from the Location Data Logic. According to some embodiments, the Venue Retrieval Logic may reference 3^{rd} party venue database providers (e.g. Foursquare) and retrieve the listing of venues in proximity with the location indicated by the location data, and/or the location of one of the ‘visit’ and/or ‘place’ record(s). According to some embodiments, the listing of venues may include multiple proximate ‘venue’ records, wherein a ‘venue’ record may include, but is not limited to: (1) Venue name; (2) Venue coordinates; (3) Venue type (e.g. restaurant, shop, show); (4) Venue popularity; (5) Venue operating hours; and/or (6) Venue popular or peak hours.

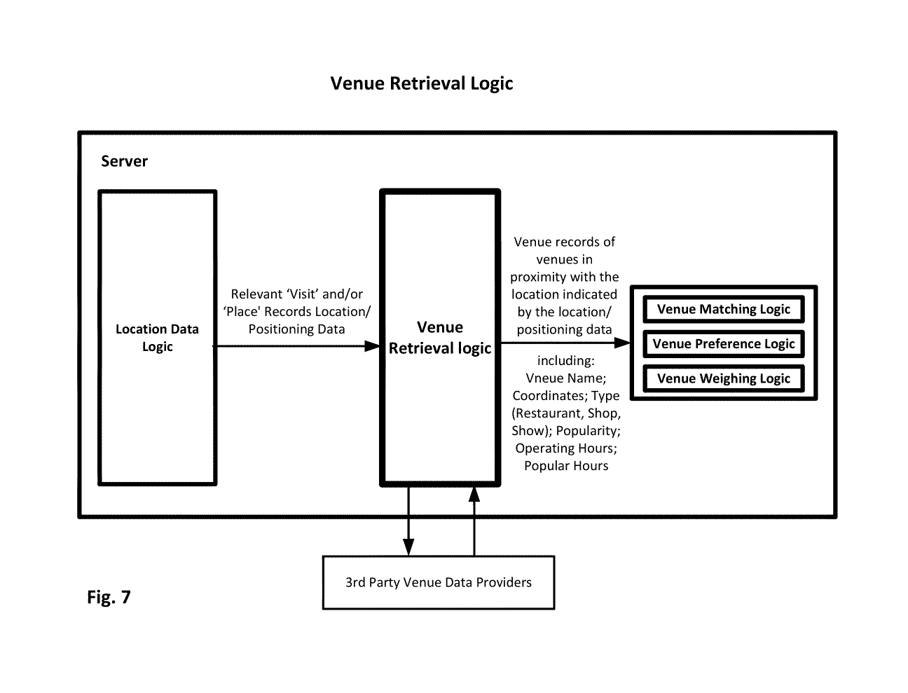

In FIG. 7 there are shown, the main modules, components, and relationships, of an exemplary venue retrieval logic, in accordance with some embodiments of the present invention.

According to some embodiments, the Venue Matching Logic may score each of the location proximate venues in the retrieved listing by matching the locations of each of the retrieved venues to: communication signal beacons/samples detected by the device within proximity of the location indicated by the location data, and/or to the location of the ‘visit’ and/or ‘place’ record(s). According to some embodiments, the retrieved venues may be ranked/scored in accordance with their distance from the coordinates of the ‘visit’ and/or ‘place’. The function for translating the distance into a probability score may factor accuracy estimations made for, or received with each of, multiple subject's device location samples made during a ‘visit’ or at a ‘place’; and/or accuracy estimation(s) made for optimized ‘best’ location(s) determined for a the ‘visit’ and/or the ‘place’. According to some embodiments, the parameters used in the function may be optimized using ground truth data (e.g. authenticated position/location of a venue) to achieve optimal matching results.

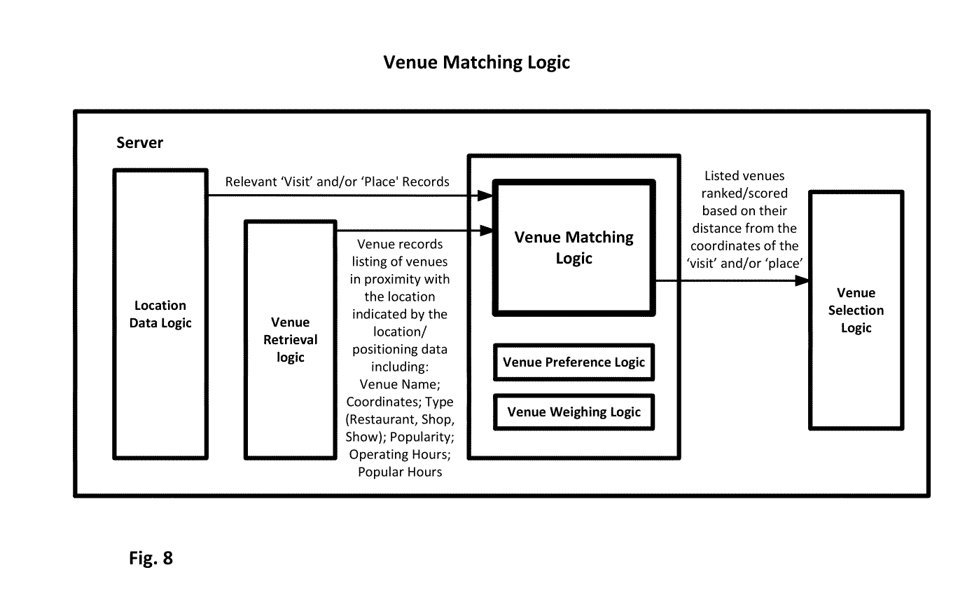

In FIG. 8 there are shown, the main modules, components, and relationships, of an exemplary venue matching logic, in accordance with some embodiments of the present invention.

According to some embodiments, the Venue Preference Logic may comprise a: (1) User Profile Building Module for: interfacing with one or more of the subject's device modules and utilizing them to collect subject preferences indicative information, and/or for referencing 3rd party personal details database providers (e.g. government agencies, private organizations) and/or 3^{rd} party social networks and databases (e.g. Facebook) and retrieving subject preferences indicative information; and/or (2) a User Preferences Analysis Module for: generating, at least partially based on the collected subject preferences indicative information, a profile or preferences list of the subject, and/or for scoring each of one or more of the listed venues by applying them with a subject preference value based on the generated profile or preferences list of the subject.

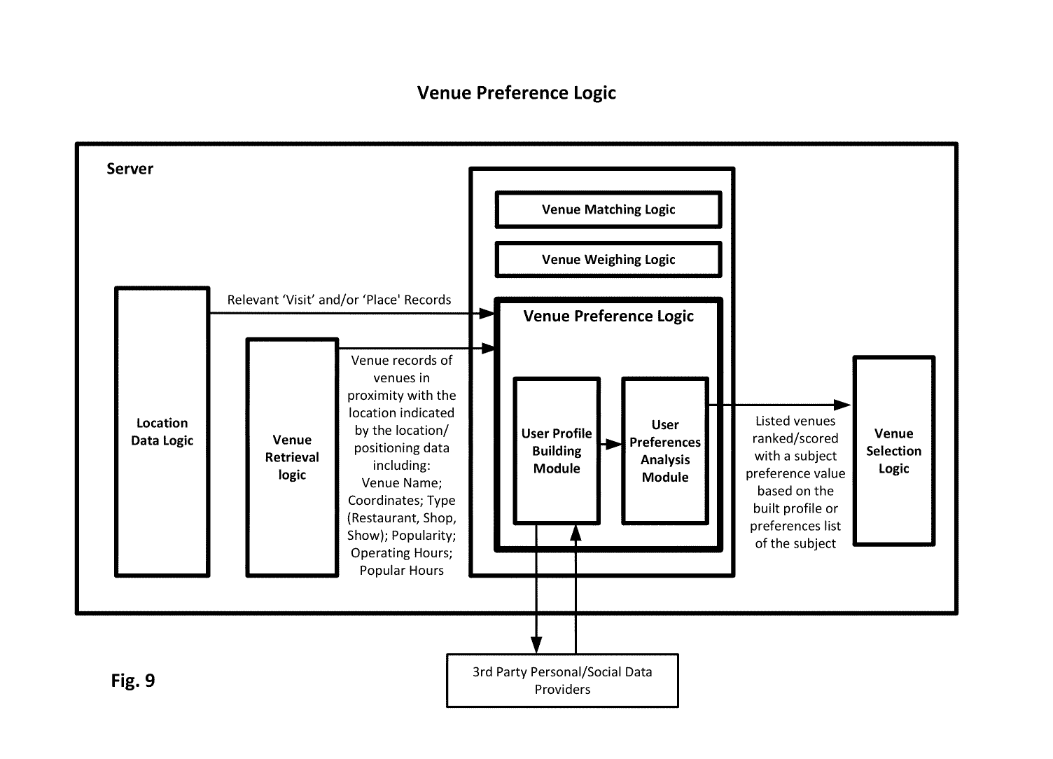

In FIG. 9 there are shown, the main modules, components, and relationships, of an exemplary venue preference logic, in accordance with some embodiments of the present invention.

According to some embodiments, the Venue Weighing Logic may apply heuristic based scoring, weighting and/or filtration to the listed venues. According to some embodiments, the Venue Weighing Logic may comprise: (1) a Residence Classification Module for identifying visits to private residential places, and/or providing a probability estimate for whether a given subject visit made to a place (e.g. a specific ‘visit’ record), was a visit to a private residential place or a visit to a venue; and/or (2) a Heuristic Scoring Module for weighing and comparing one or more features and/or characteristics of a given subject visit made to a place (e.g. a specific ‘visit’ record), and possibly a ‘place’ record(s) associated with the visit, to ‘venue’ records of venues present in the listing of venues found in proximity to the location of that visit; and for accordingly scoring the matching level between each of the proximate venues to the place of visit.

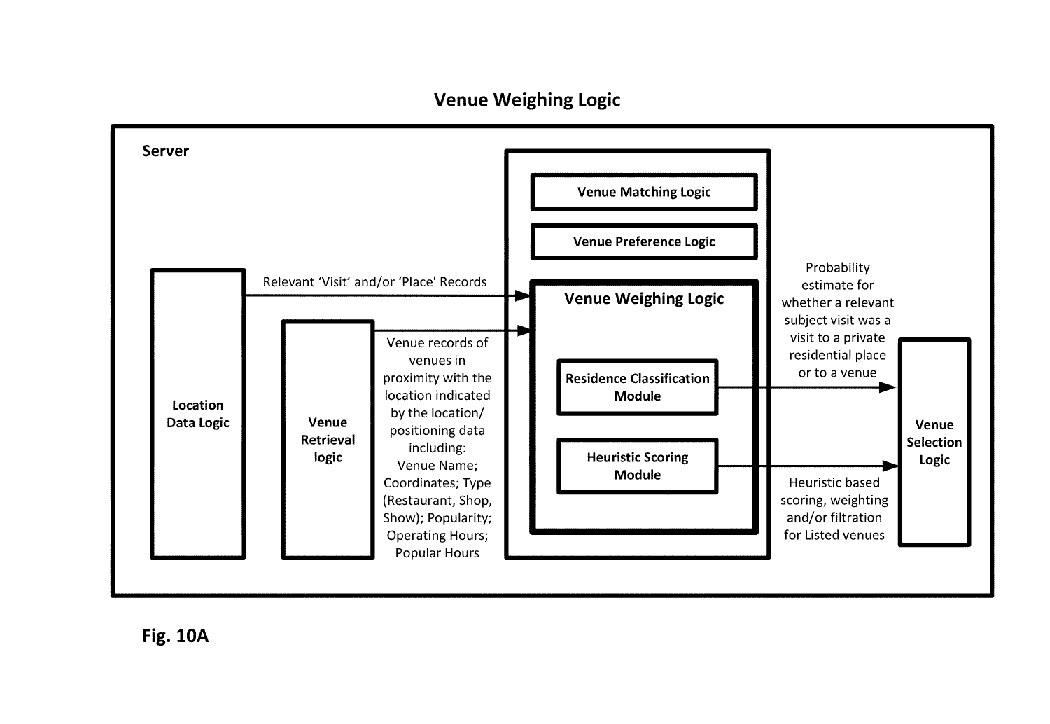

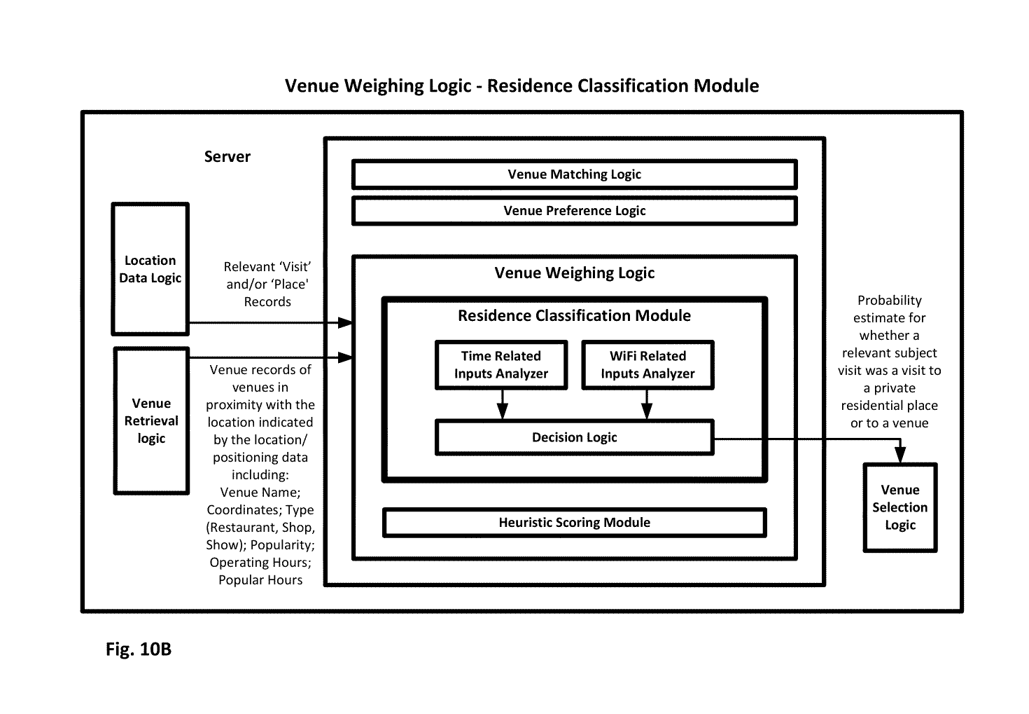

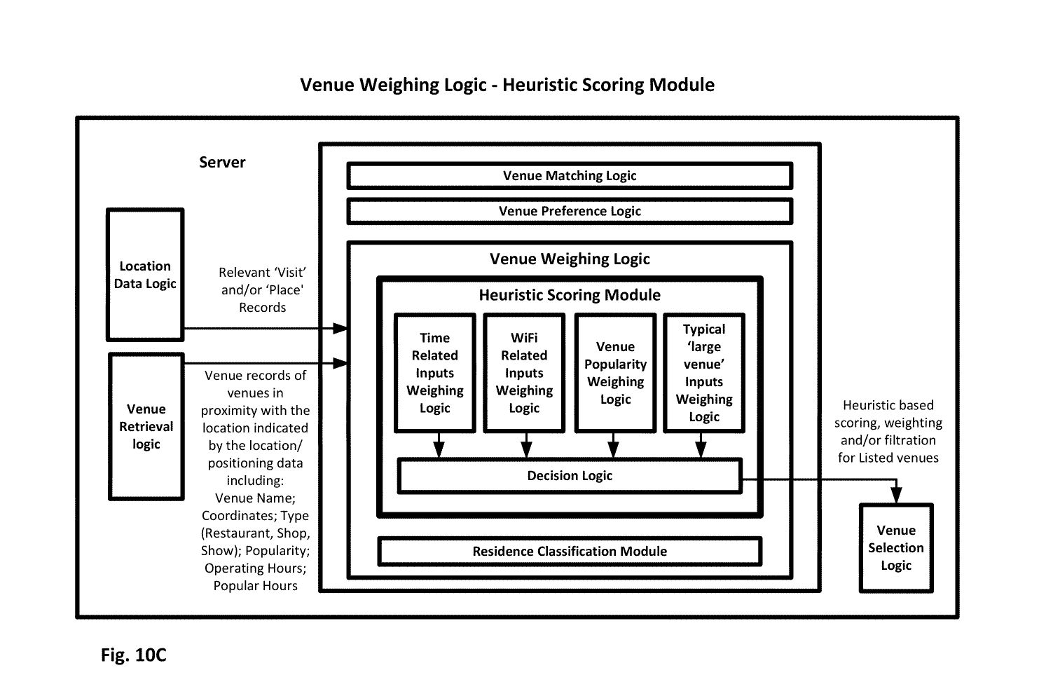

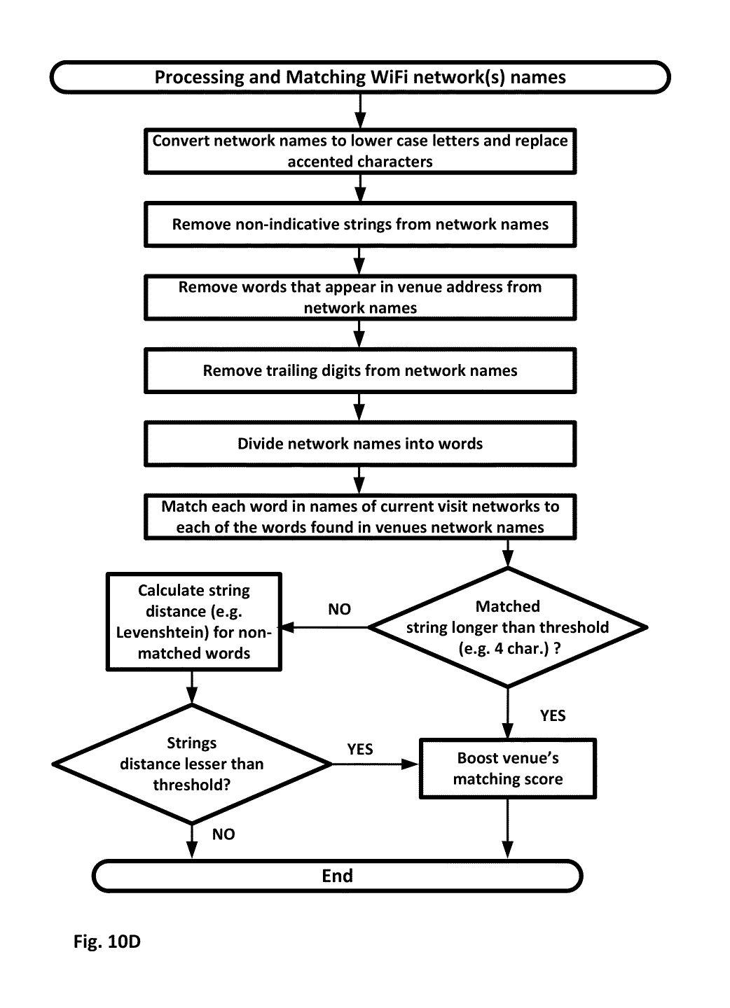

In FIG. 10A there are shown, the main modules, components, and relationships, of an exemplary venue weighing logic, in accordance with some embodiments of the present invention.

According to some embodiments, the Residence Classification Module may identify whether the subject has visited (e.g. a specific ‘visit’ record) a venue or a private residential place, such that a subject visit to a residential place in proximity to a venue, is not registered as an actual visit to that venue.

According to some embodiments, the Residence Classification Module, as part of identifying a visit as a visit to a residential place, may collect and/or analyze the following inputs and/or input types: (1) Time related inputs: (a) visit length analysis, visit length average and/or other visit length statistics (e.g. a place having an average visit length of more than 2.5 hours is more likely to be residential), (b) visit ‘time of day’ analysis (e.g. a place typically visited overnight is more likely to be residential), and/or (c) visit arrival and leaving time analysis (e.g. a place typically arrived at in the evening and left in the morning is more likely to be residential); and/or (2) WiFi related inputs such as active-networks and WiFi-scans related inputs: (a) Identification of expressions commonly constituting, and/or partially found in, residential SSIDs (e.g. “home”, “family”, “house”, “maison”, “2wire”, “hpsetup”), (b) Identification of expressions commonly constituting, and/or partially found in, venue SSIDs (e.g. “staff”, “customer”), (c) Identification of private names and/or surnames that are usually more common in residential SSIDs, constituting, and/or partially found in, SSIDs (e.g. “David”, “John”, “Mary”, “Miller”), and/or (d) identification of default router SSIDs that are usually more common in residential SSIDs, constituting, and/or partially found in, SSIDs (e.g. “Netgear”, “Linksys”).

In FIG. 10B there are shown, the main modules, components, and relationships, of an exemplary venue weighing logic—residence classification module, in accordance with some embodiments of the present invention.

According to some embodiments, the Residence Classification Module may comprise a decision logic for analyzing the inputs of a given subject visit, scoring the visit on each of the inputs, and/or normalizing and assigning weights to each of the visit inputs scores. The scores of the visit or derivations thereof, possibly factoring the weights, may be aggregated to a visit probability estimate for whether the subject visit made to a place (e.g. a specific ‘visit’ record), was a visit to a private residential place or a visit to a venue.

According to some embodiments, the Heuristic Scoring Module for weighing and comparing one or more features and/or characteristics of a given subject visit made to a place (e.g. a specific ‘visit’ record), and possibly a ‘place’ record(s) associated with the visit, to ‘venue’ records of venues present in the listing of venues found in proximity to the location of that visit; and for accordingly scoring the matching level, for each of the features and/or characteristics compared, between each of the proximate venues to the place of visit. According to some embodiments, the Heuristic Scoring Module may weigh and compare visit and/or venue features and/or characteristics including, but not limited to: (1) WiFi related characteristics; (2) Time related characteristics; (3) Venue popularity related characteristics; and/or (4) typical characteristics of ‘large venues’.

In FIG. 10C there are shown, the main modules, components, and relationships, of an exemplary venue weighing logic—heuristic scoring module, in accordance with some embodiments of the present invention.

According to some embodiments, the Heuristic Scoring Module, as part of weighing and comparing one or more WiFI related features and/or characteristics of a given subject visit to proximate venues may compare and match the names of active and/or scanned WiFi networks during the visit to the names of the listed proximate venues (e.g. Tokyo Sushi—tokyosushi; Jackalope Brewing Company —Jackalope-guest; Audio Express—audioexpress04). The name of the WiFi network is not similar in many cases to the venue name, and may: include additional prefixes/suffixes, contain only one word out of the venue name, have missing spaces or slightly different spelling, exchange small letters to capital letters, include—for languages which use accented roman characters—the same letters but without the accent, and/or the like.

According to some embodiments, the Heuristic Scoring Module, may employ one or more heuristic processing rules to the WiFi network(s) names and then utilize a matching function(s) (e.g. the Levenshtein distance function) to measure the ‘distance’ between a given processed set of one or more WiFi network names active and/or scanned during the visit to the names of the listed proximate venues. The processing rules may include: (1) converting all letters to lowercase, and replacing accented characters to their non-accented version (e.g. á-a), in both the WiFi SSIDs and/or the listed venue names; (2) removing common non-indicative strings from WiFi SSIDs (e.g. “guest”, “wlan”, “free”); (3) removing or ignoring words which appear in the address of the place (e.g. name of street or city) from both WiFi networks and/or the listed venue names; (4) removing trailing digits from words in WiFi SSIDs which start with letters (e.g. audioexpress04-audioexpress); (5) for each tested pair of a WiFi Network and a listed venue name (e.g. a single WiFi SSID and a single venue name): (a) dividing both names into words; (b) attempting to match different combinations of words from each input (e.g. word 1 from WiFi SSID against word 1 from venue name, words 1 and 2 against word 1) wherein the matching process includes: (i) If either of the combined strings is less than 4 letters long, ignore this word combination, (ii) if both strings are 4 letters long and are exactly similar, consider this combination a match, and/or (iii) if both strings are at least 5 letters long, calculate the Levenshtein distance between the strings, which is defined as the minimal number of character substitutions, deletions and insertions for transformation of string A into string B, wherein the match score may be defined as: [score=(levenshtein_dist(A,B)−abs(length(A)−length(B)))/min(length(A),length(B))]; and/or (c) taking the lowest score(s) between all valid word combinations for the strings pair, and wherein a score of, or below, a predetermined threshold (e.g. 0.2) may be considered a match; and/or (6) Boosting the overall match score of venue(s) that were matched to a WiFi SSIDs at the place of the visit, and therefore increasing their chance to be selected as the venue for this place of visit.

In FIG. 10D there are shown, the main processes and steps of an exemplary WiFi networks names matching scheme implemented by a Heuristic Scoring Module, as part of weighing and comparing one or more WiFi related features and/or characteristics of a given subject visit to proximate venues, in accordance with some embodiments of the present invention.

According to some embodiments, the Heuristic Scoring Module, may log and utilize past visits data (e.g. ‘place’ records of the same place, former ‘visit’ records to the same place) in which the correct/verified venue was known (e.g. by user selection/verification, by matching against other information about the user such as credit card charges history), thus building a ‘WiFi fingerprint’, and/or ‘Network(s) Signal(s) Fingerprint’, for each of the correct/verified venues. According to some embodiments, a ‘WiFi fingerprint’ may include a list of WiFi access points most commonly seen (e.g. found in device scans, device was connected to) by devices while visiting a correct/verified venue, enabling an increased likelihood for selecting the correct venue in ambiguous scenarios (e.g. a shopping mall with many different stores, where location accuracy is typically not high enough to distinguish between the different stores).

According to some embodiments, the Heuristic Scoring Module, may compare Information about the venue opening hours, the typical length of stay, and/or indication(s) of the popular hours of the venue (e.g. as derived from user ‘check-ins’)—against the hours of day, and/or the days of the week, in which the subject has visited the place, and/or against the length(s) of the subject's visit(s) and/or parameters derived therefrom, (e.g. using the current visit times and/or the times of past visits by the present subject and/or other subject(s) to the same place). According to some embodiments, the Heuristic Scoring Module may boost the overall match score, and/or increase the selection probability, of venue(s) having opening hours matching the visit(s) times. Venues having non-matching hours may incur a penalty to their overall match score and/or to their selection probability (e.g. a visit of 1.5 hours at noon is very likely to be to a restaurant, a visit of 20 minutes at night is very unlikely to be to a golf course).

According to some embodiments, popular hours and popular visit lengths may be derived for various venue categories (e.g. restaurants, shops, etc.)—these may be learned by aggregating data from all subject devices in the system. Accordingly, the Heuristic Scoring Module, may further compare information about the venue category—against the hours of day, and/or the days of the week, in which the subject has visited the place, and/or against the length(s) of the subject's visit(s) and/or parameters derived therefrom.

According to some embodiments, the Heuristic Scoring Module, may utilize the subject's visit hours (e.g. arrival, leaving) to determine whether the subject has stayed overnight in a place. An overnight stay may be regarded as a visit a residential place, and/or to a specific type(s) of venues (e.g. a hotel, a hospital, a camping site). According to some embodiments, the Heuristic Scoring Module, upon determining that the user has stayed overnight in a place, may filter out from the listed venues, venues of non-overnight stay type, and/or limit the proximate venue search to overnight stay venue types.

According to some embodiments, the Heuristic Scoring Module, may factor the popularity of each of the proximate listed venues, for example, the number of different subjects which have visited/checked-in at each of the venues, based on retrieved 3rd party venue information and/or ‘place’ records for which a venue match has been verified. According to some embodiments, the Heuristic Scoring Module may boost the overall match score, and/or increase the selection probability, of venue(s) having higher popularity and vice versa. According to some embodiments, venues having a very low popularity rank may in fact be wrong or irrelevant listings, and may be filtered out. According to some embodiments, the venues' popularity level may further be relayed to, and utilized by, the Residence Classification Module in the process of deciding if a place, to which a visit was made, is a public venue or a private residence.

When querying for venues around a specific location, each resulting venue is supplied with an estimation of its real world location. Nevertheless, while most real world venues are relatively small in area (e.g. a restaurant, a local shop), others can be spread on large areas (e.g. airports, stadiums, shopping malls, hospitals). This may pose a challenge, since even a location with high accuracy level may still be hundreds of meters away from the “venue coordinates” which at best may point to center of the venue area. According to some embodiments, the Heuristic Scoring Module, may maintain a list of venue categories which are considered large places that are treated differently. The list may be built automatically using past data (e.g. a ‘place’ record(s)) in which the correct venue was known/verified for certain visits, and may include the ‘typical size’ for each type of venue (e.g. restaurant —small, department store—medium, airport—large).

According to some embodiments, some or all of the parameters, scores, ranks and/or weights assigned to venues by the Venue Weighing Logic, and/or any sub module/logic thereof, may be verified and/or optimized using ground truth data (e.g. authenticated position/location of a venue) to achieve more accurate results. According to some embodiments, based on the ground truth data, relative weights of each of the data factors (i.e. parameters, scores, ranks and/or weights assigned) in the final decision may be optimized. Accordingly, venue data for which ground truth support has been established, may receive a higher score or weight in the final venue selection decision, than a similar non ground truth verified venue. According to some embodiments, ground truth support may include any form of confirmed data that may verify/support parameters, scores, ranks and/or weights assigned to venues by other system modules (e.g. Venue Weighing Logic and its sub modules/logics). Ground truth data may include, but is not limited to: System data authentication made by subject (e.g. check-in ‘I am in McDonald's on Broadway’); System data authentication made by subject accompany (e.g. subject friend check-in ‘I am in McDonald's on Broadway with Subject’) Subject credit card transaction details (e.g. ‘Subject credit card used/charged at McDonald's on Broadway’); Reliable matching between venue name and SSID of connected/strongest WiFi signal (e.g. subject near McDonald's on Broadway and device connected to a network named ‘McDonalds’); and/or the like.

According to some embodiments, the Venue Selection Logic may comprise a decision logic for analyzing the matching scores, for each of the features and/or characteristics compared, between each of the proximate venues listed and the given subject visit; and/or normalizing and assigning weights to each of the matching scores wherein the weight may be at least partially based on the type of the given feature and/or characteristic compared. According to some embodiments, for each venue and subject visit comparison, the matching level scores or derivations thereof, possibly factoring the weights, may be aggregated to a venue-visit matching probability estimate that may also be referred to as a ‘venue presence likelihood value’. Using a combination of all the factors described above, the decision logic may choose one of the proximate venues listed, for example the venue(s) having the highest ‘venue presence likelihood value(s)’, as the matched venue for the place of visit. Alternatively, the decision logic may reach a decision not to select a matching venue to the place of visit, assuming the place is a private residence (e.g. based on inputs from the Residence Classification Module), and/or a venue which was not listed.

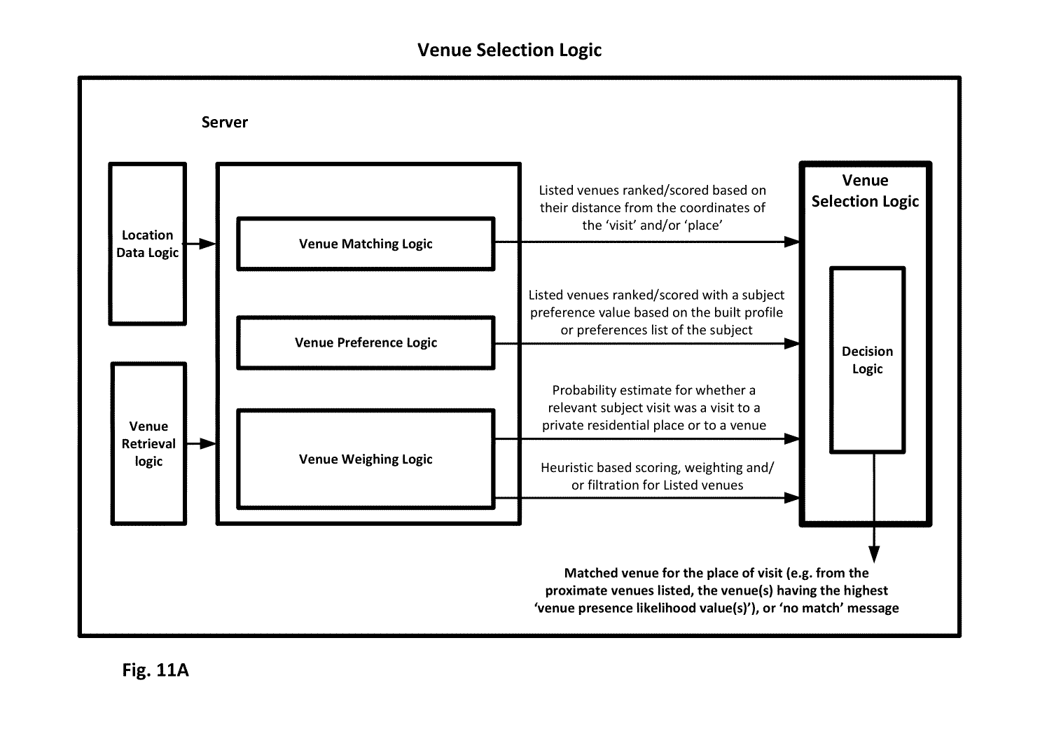

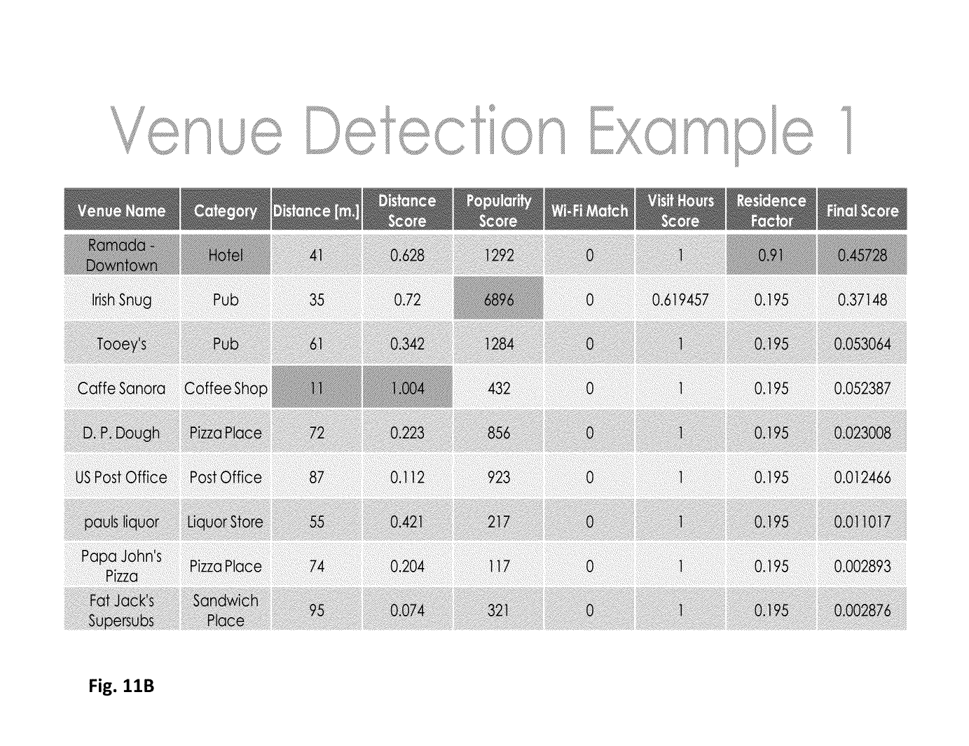

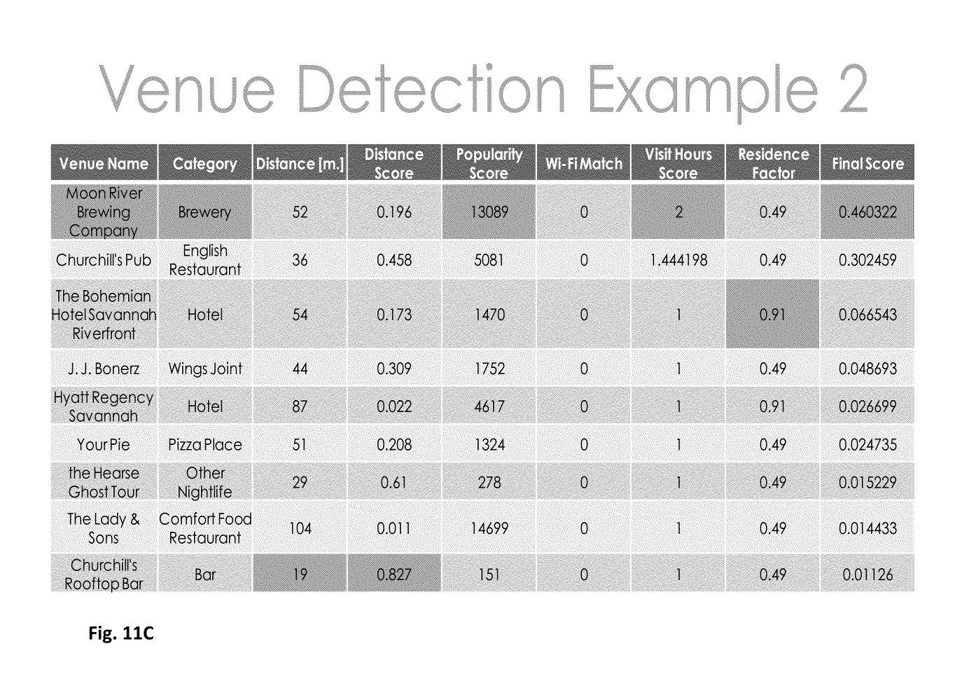

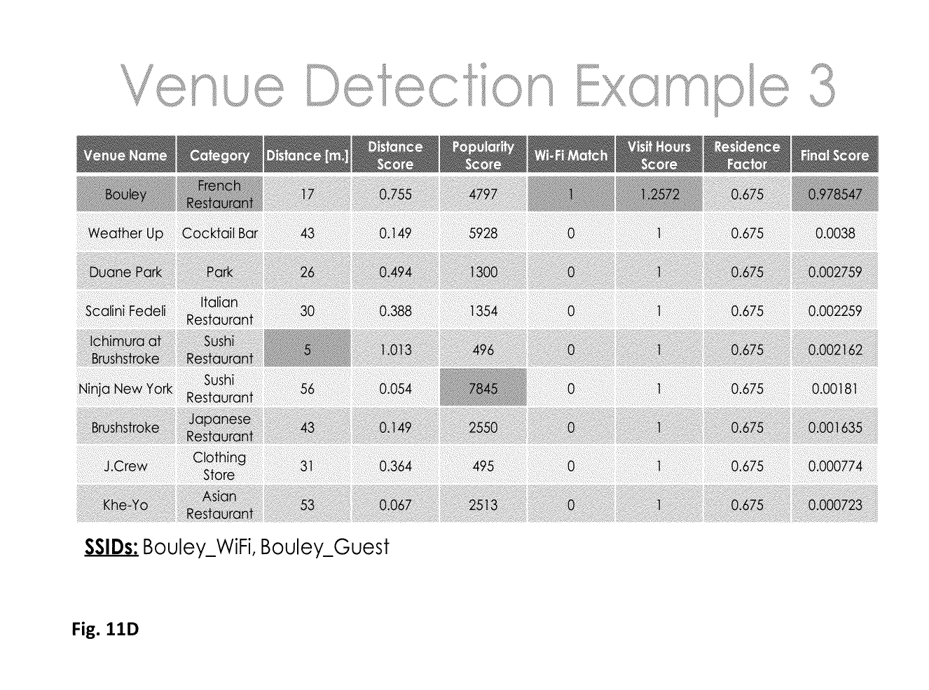

In FIG. 11A there are shown, the main modules, components, and relationships, of an exemplary venue selection logic, in accordance with some embodiments of the present invention.

In FIGS. 11B-11D are tables showing exemplary venue scoring scenarios, wherein an exemplary venue selection logic scores and ‘selects’ (highest score) a venue, based on several records for each of a set of venues found to be in proximity to the location of a subject made visit, in accordance with some embodiments of the present invention.

Assessment of a presence likelihood of a subject at one or more venues, in accordance with some embodiments of the present invention, and the associated techniques described hereinbefore, may apply to, be used for, facilitate, or benefit, various applications; including the following, exemplary, non limiting applications:

Location Based Coupons/Daily Deals Recommendation Engine—

The technology can be used to build coupon/local deals recommendation engine. Using the profiling technology, one can automatically learn both: the geographic routine of the user (where he lives, where he works, where he likes to hang out after work etc.), and his interests according to the types of places he visits frequently (shops, restaurants, gym, etc.). Using the combination of both, it is possible to filter and/or rank coupons and deals available in the user's geographic area to include only the most relevant ones for him.

Anti-Fraud for Credit Cards—

Based on user locations, and by correlating them with credit card transaction data, one can detect if a credit card transaction is legitimate or fraudulent. This can be done both: as an offline post-purchase service, or in real time.

Profiling for Credit Score—

The technology may be used to enrich and validate the credit scoring of a loan applicant. The technology can validate many aspects of the application, such as: Home address, Work address, Weekly work hours.

Additionally, collected insights can enrich the credit scoring in many ways: User mode of transportation (owns a car/public transportation), spending habits (restaurants, shops etc.).

Profiling for Right on Time Notification—

The profiling technology can learn the geographic and phone usage routine of the user. Using this information, one can derive the best time to approach a user with push content. For example:

A user downloaded a game but stopped playing it after a while. Using the profiling technology we can learn that the user is using public transportation to get to work, and uses apps on his phone during the ride; engage him when he's on his way to work with a bonus in the game.

A user uses news apps after he arrives home in the evening. Detect his arrival back home and send him a daily news digest 30 minutes after he gets home.

A user often takes a lunch break from work and eats in one of the restaurants around his office. Send him a notification with specials/discounts in restaurants nearby, 30 minutes before he usually starts his break. Alternatively, suggest him deals in restaurant that make deliveries to his work address.

Complete Online Purchase Intents in Brick & Mortar Stores by Integrating Location Technology—

User has added an item to his app shopping cart or wish list. Using the technology, detect the user is currently next to a physical store that sells this item, and notify the user so he can check the item in the store. This is specifically relevant for fashion items, where the physical fitting is important and can't be evaluated online.

“In the Market” Intents—

Using the profiling technology, one can detect several market intents of the user. For example: user visited several car dealerships recently→user is interested in buying a new car→suggest him deals on cars/loan offers; user visited several open houses→user is interested in buying a house→suggest him mortgage offers.

House Move—

Using the location technology, it is easy to quickly detect that the user has moved to a new apartment. This information could be very valuable to local businesses, which would like to acquire the user as a repeating customer, and could offer him strong incentives that could establish such loyalty. For example: first haircut free, 50% off on first laundry service, free coffee.

Automated Carpool Suggestions—

Given a large pool of users which are tracked with the technology, it is possible to automatically detect users with similar commute habits: they live close to each other, their work places are close to each other, and they commute in roughly the same hours. The system can then suggest those users to connect with each other and share rides. This can be done without compromising the user's privacy, in a manner that does not expose any user information before both users express interest in connecting.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A system for estimating a presence of a subject at a given venue, said system comprising:
a mobile device carried by a subject and adapted to transmit time stamped location data to a location ambiguity resolution server; and
a location ambiguity resolution server adapted to:
(a) receive time stamped location data from the device carried by the subject;
(b) retrieve a listing of venues in proximity with location indicated by the location data; and
(c) apply heuristic based score weighting or filtration to the listed venues.

2. The system according to claim 1 wherein the location ambiguity resolution server is further adapted to score each of one or more of the listed venues by applying a subject preference value.

3. The system according to claim 1 wherein the location ambiguity resolution server is further adapted to infer the start time and end time of a given subject visit to a place, based on the received time stamped location data.

4. The system according to claim 3 wherein the location ambiguity resolution server, as part of applying heuristic based score weighting or filtration, is adapted to estimate the probability of whether the time stamped location data received from the subject carried device, is indicative of a residential place or a public venue.

5. The system according to claim 4 wherein the location ambiguity resolution server estimates the probability at least partially based on the length of the subject visit inferred from the subject visit start time and end time.

6. The system according to claim 4 wherein the location ambiguity resolution server estimates the probability at least partially based on the time of day of the subject visit inferred from the subject visit start time and end time.

7. The system according to claim 4 wherein the location ambiguity resolution server estimates the probability at least partially based on the names of WiFi networks detected by the subject device between the subject visit start time and end time.

8. The system according to claim 3 wherein the location ambiguity resolution server, is further adapted to compare characteristics of WiFi networks and access points, detected by the subject device between the inferred start time and end time of the given subject visit, to characteristics of WiFi networks and access points most commonly detected by mobile devices in prior visits to the venues in proximity with location indicated by the location data.

9. The system according to claim 3 wherein the location ambiguity resolution server is further adapted to infer the length of the subject visit and the time of day of the subject visit from the subject visit start time and end time; and
score each of one or more of the listed venues by applying a comparison between the inferred length and time of day of the subject visit to typical visit time lengths and visit times of day of venue types that are found within the listed venues.

10. The system according to claim 1 wherein the location ambiguity resolution server is further adapted to reference a listing of large venues, and to include in the retrieved listing of venues, large venues in lower proximity to the location indicated by the location data.

11. The system according to claim 1 wherein the mobile device, further comprises a data collection logic adapted, as part of transmitting time stamped location data to a location ambiguity resolution server, to employ an energy saving scheme wherein: upon detecting that the subject device is substantially static, a predetermined number of time stamped location data samples are taken over a given time period, and wherein further time stamped location data samples are taken following to the subject device being substantially dynamic for a given period of time and returning to a substantially static state.

12. A method for estimating a presence of a subject at a given venue, said method including:
receiving time stamped location data from a mobile device carried by the subject;
retrieving a listing of venues in proximity with location indicated by the location data; and
applying heuristic based score weighting or filtration to the listed venues.

13. The method according to claim 12 further including scoring each of one or more of the listed venues by applying a subject preference value.

14. The method according to claim 12 further including inferring the start time and end time of a given subject visit to a place, based on the received time stamped location data.

15. The method according to claim 14 further including estimating the probability of whether the time stamped location data received from the subject carried device, is indicative of a residential place or a public venue.

16. The method according to claim 15 further including estimating the probability at least partially based on the length of the subject visit inferred from the subject visit start time and end time.

17. The method according to claim 15 further including estimating the probability at least partially based on the time of day of the subject visit inferred from the subject visit start time and end time.

18. The method according to claim 15 further including estimating the probability at least partially based on the names of WiFi networks detected by the subject device between the subject visit start time and end time.

19. The method according to claim 14 further including comparing characteristics of WiFi networks and access points, detected by the subject device between the inferred start time and end time of the given subject visit, to characteristics of WiFi networks and access points most commonly detected by mobile devices in prior visits to the venues in proximity with location indicated by the location data.

20. The method according to claim 14 further including inferring the length of the subject visit and the time of day of the subject visit from the subject visit start time and end time; and
scoring each of one or more of the listed venues by applying a comparison between the inferred length and time of day of the subject visit to typical visit time lengths and visit times of day of venue types that are found within the listed venues.

21. The method according to claim 12 further including referencing a listing of large venues, and including in the retrieved listing of venues, large venues in lower proximity to the location indicated by the location data.

22. The method according to claim 12 further including employing an energy saving scheme wherein: upon detecting that the subject device is substantially static, a predetermined number of time stamped location data samples are taken over a given time period, and wherein further time stamped location data samples are taken following to the subject device being substantially dynamic for a given period of time and returning to a substantially static state.
